(19) United States
(12) Patent Application Publication
(10) Pub. No.: US 2010/0057545 A1
(43) Pub. Date: Mar. 4, 2010

(54) SYSTEM AND METHOD FOR SENDING SPONSORED MESSAGE DATA IN A COMMUNICATIONS NETWORK

(76) Inventors: Daniel Jean, Atlanta, GA (US); Thomas Cobb, Marietta, GA (US)

Correspondence Address: AT&T Legal Department - Roebuck;Attn: Patent Docketing, One AT&T Way,, Room 2A-207, Bedminster, NJ, 07921, US

(21) Appl. No.: 12/199,830

(22) Filed: Aug. 28, 2008

(51) Int. Cl. G06Q 30/00

(52) U.S. Cl. 705/14.4

(57) ABSTRACT

A computerized system for sending sponsored data is disclosed, including but not limited to a processor in data communication with a computer readable medium; a computer program containing instructions to monitor video data for products data presented in the video data; instructions to encode product advertising data for at least one of the products data presented in the video data; instructions to send at least one of a plurality of products sponsor passwords data to a first end user device for decoding the products advertising data encoded in the video data; instructions to receive message data from the first end user device; instructions to send message sponsor password data to a second end user device selected by the first end user device; and instructions to send the message data encoded using the message destination password data to the second end user device.

### FIELD OF THE DISCLOSURE

The present disclosure relates to the field of television advertising.

### BACKGROUND OF THE DISCLOSURE

Targeted advertisements have historically been mailed to large targeted geographic areas such as a particular city, so that regional advertisers reach only persons who are deemed by the advertiser as most likely to be responsive to their advertisements.

Advertisements are a component in digital video services, including live or pre-recorded broadcast television (TV), special or pay-per-view programming, video on demand (VOD), and other content choices available to subscribers.

### BRIEF DESCRIPTION OF THE DRAWINGS

FIG. 1 depicts an illustrative embodiment of a system for sending sponsored messaging data;

FIG. 2 depicts a flow chart of functions performed in an illustrative method for sending sponsored messaging data;

FIG. 3 depicts a flow chart of functions performed in another illustrative method for sending sponsored messaging data;

FIG. 4 depicts a data structure embedded in a computer readable medium that is used by a processor and method for sending sponsored messaging data; and

FIG. 5 depicts an illustrative embodiment of a machine for performing functions disclosed in an illustrative embodiment.

### DETAILED DESCRIPTION

In a particular illustrative embodiment, a system and method are provided as part of a end user's internet protocol television (IPTV) service. A particular embodiment enables an end user at an end user device to obtain advertising data including but not limited to location, price and other information about an advertiser's product live during an IPTV advertisement. During an IPTV video presentation, in an illustrative embodiment a system and method highlights selected products appearing in the video presentation and enables the end user at an end user device to obtain advertising data indicating a product location for a product or to obtain additional information about the product and the advertiser. In a particular embodiment, the advertising data is encoded into the video data sent to an end user device using a product sponsor password. The advertiser provides the product sponsor password to enable an end user to obtain the encoded advertising data. A product sponsor password such as “Zippy Pizza” is provided and displayed on the end user device so that the end user has to enter the product sponsor password word “Zippy Pizza” using a data entry device such as a remote control at an end user device, such as for example, a set top box in an IPTV network to decode the advertising data.

The advertiser chooses a password that will make a commercial product impression on an end user at an end user device, whom must enter the sponsor password into the end user device to decode and display the advertising data. An end user is also provided sponsored messaging between end user devices. Thus, a first end user who opens the encoded Zippy Pizza advertising data using the sponsor password may also enter message data at the end user device to send an encoded message to another end user device via the IPTV network. The first end user designates a destination end user device of their choice to receive the sponsored message data via the IPTV network. The sponsored message is encoded using the message sponsor pass word and sent to the end user at the destination end user device whom must enter the message sponsor password to open the message. Thus, the advertiser receives additional commercial impressions of end users being exposed to the message sponsor password by requiring each end user who receives a sponsored message from the first end user device to enter the message sponsor password to open the encoded sponsored message. End user device messaging between end users is tracked so that end users whom send the most sponsored messages are selected for special advertising offers which will be disseminated by these end users whom send the most messages to obtain additional commercial impressions.

The video data is monitored using a deep packet inspection (DPI) and content recognition (CR) module, implemented in software and hardware, to recognize products present in the video data stream and data exchanged between end users. Advertisers present advertising data keys to the IPTV system so the IPTV system can look for advertising opportunities in the video data. For example, a bicycle company who sells “Speedeez Racer” bikes may request advertising placement during the Tour de France. An advertising data key such as a reference image for a bicycle is placed in the advertising data base as a product data key. In another embodiment reference image and a watermark for the reference image for a bicycle are provided to verify the identity of the bicycle that appears in the video data. The IPTV system monitors the video data for the Tour de France for the product data key, thus when a bicycle is presented in the video data stream as an image, an audible word or in text, the image or text of the bicycle is highlighted to indicate that sponsored advertising data is available to the end user at an end user device. The product sponsor password is presented to the end user at the end user device. An end user selects the highlighted bicycle text or image data as a sponsored product to receive sponsored advertising data and send sponsored messages using the message sponsor password “Speedeez Racer Bikes”.

The end user would be able to obtain a map with locations and directions to the closest location offering the product, as well as the other features and information. In an illustrative embodiment a system and method monitors the video data stream and when the appropriate advertisement is shown, and gives the viewer the option of finding out more information about that advertiser. When the viewer chooses to get more information about the highlighted product, the system and method interact with an advertising server data base to access advertising data about the product. This advertising data is displayed to the end user on the end user device along with a current video data stream. This advertising data can include but is not limited to contact information, hours of operation, special promotions and other product information. The system and method uses the viewer's location to derive some customized information such as closest location to the viewer, directions, and mapping features. This advertising data can then be sent to a mobile phone or personal data assistant (PDA) via email and/or simple messaging protocol (SMP), which can then be imported into that phone's geo positioning system (GPS) navigation system.

The benefits to the end user are real time information about products that is customized to the advertisers' location and to their current viewers which saves the end user from having to search for information at a later time using different media. Advertisers benefit because they are able to interact with end user in real time while advertisement data is fresh in the end user's mind and they are more likely to follow through on a call to action.

In another illustrative embodiment a computer readable medium is disclosed containing a computer program including but not limited to instructions, the computer program including but not limited to instructions to monitor video data for products data presented in the video data; instructions to encode product advertising data for at least one of the products data presented in the video data; instructions to send at least one of a plurality of products sponsor passwords data to a first end user device for decoding the products advertising data encoded in the video data; instructions to receive message data from the first end user device; instructions to send message sponsor password data to a second end user device selected by the first end user device; and instructions to send the message data encoded using the message sponsor password data to the second end user device. In another embodiment of the medium, at least one products sponsor password data and the message sponsor password data indicate at least one advertising term selected from an advertising sponsor data base. In another embodiment of the medium, the products sponsor passwords data and the message sponsor data are the same.

In another embodiment of the medium, the instructions to monitor the video data further comprise instructions to recognize data in the video data containing at least one of product image data, product aural data and product textual data and advertising data key data exchanges between the first end user device and the second end user device using a content recognition computerized function. In another embodiment of the medium, the computer program further including but not limited to instructions to send product presentation highlight data to the first end user device to highlight at least one of the products data presented in the video data wherein the products data is chosen from the products data presented in the video data. In another embodiment of the medium, the computer program further includes but is not limited to instructions to receive product selection data from the first end user device wherein the products data indicates one of the products data highlighted; and instructions to verify in a product data base a product identity for the product selection data received from the end user device.

In another embodiment of the medium, the computer program further includes but is not limited to instructions to send selected product advertising data to the first end user device wherein the selected product is selected based on the product data exchanges between the first end user device and the second end user device. In another embodiment of the medium, the computer program further including but not limited to instructions to encode each of a plurality of products advertising data for products data presented in the video data using at least one of a plurality of products password data; and instructions to send data indicating at least one of the plurality of products sponsor passwords data to each of a plurality of end user devices for decoding the advertising data encoded in the video data. In another embodiment of the medium, the advertising sponsor password data is an advertising sponsor password associated with the product data.

In another illustrative embodiment, a computerized system for sending sponsored data, the system including but not limited to a processor in data communication with a computer readable medium; a computer program containing instructions for performing a method for sending advertising data, the computer program further including but not limited to instructions to monitor video data for products data presented in the video data; instructions to encode product advertising data for at least one of the products data presented in the video data; instructions to send at least one of a plurality of products sponsor passwords data to a first end user device for decoding the products advertising data encoded in the video data; instructions to receive message data from the first end user device; instructions to send message sponsor password data to a second end user device selected by the first end user device; instructions to send the message data encoded using the message destination password data to the second end user device. In another embodiment of the system, the at least one products sponsor password data and the message sponsor destination password data indicate at least one advertising term selected from an advertising sponsor data base. In another embodiment of the system, the products sponsor passwords data and the message sponsor data are the same.

In another embodiment of the system, the instructions to monitor the video data further comprise instructions to recognize data in the video data containing at least one of product image data, product aural data and product textual data and advertising data key data exchanges between the first end user device and the second end user device using a content recognition computerized function. In another embodiment of the system, the computer program further includes but is not limited to instructions to send product presentation highlight data to the first end user device to highlight at least one of the products data presented in the video data wherein the products data is chosen from the products data presented in the video data. In another embodiment of the system, the computer program further including but not limited to instructions to receive product selection data from the first end user device wherein the products data indicates one of the products data highlighted; and instructions to verify in a product data base a product identity for the product selection data received from the end user device. In another embodiment of the system, the computer program further including but not limited to instructions to send selected product advertising data to the first end user device wherein the selected product is selected based on the product data exchanges between the first end user device and the second end user device. In another embodiment of the system, the computer program further includes but is not limited to instructions to encode each of a plurality of products advertising data for products data presented in the video data using at least one of a plurality of products password data; and instructions to send data indicating at least one of the plurality of products passwords data to each of a plurality of end user devices for decoding the advertising data encoded in the video data. In another embodiment of the system, the advertising sponsor password data is an advertising sponsor password associated with the product data.

In another illustrative embodiment, a computerized system for selecting products advertising data, the system including but not limited to a first end user device having a processor in data communication with a computer readable medium; a computer program containing instructions useful for performing a method for receiving from a server in a communication network, products advertising data encoded in video data, the computer program further including but not limited to instructions to receive products data presented in the video data; instructions to decode product advertising data for at least one of the products data presented in the video data using one of a plurality of products sponsor passwords data received at the first end user device; instructions to send message data encoded using a message sponsor password from the first end user device to the second end user device; and instructions to send message sponsor password data from the first end user device to the second end user device selected by the first end user device. In another illustrative embodiment, a computer readable medium is disclosed containing a computer program including but not limited to instructions embedded in the computer readable medium for performing a method for selecting products advertising data, the computer program comprising instructions to receive from a server in a communication network, products advertising data encoded in video data, instructions to receive products data presented in the video data; instructions to decode product advertising data for at least one of the products data presented in the video data using one of a plurality of products sponsor passwords data received at the first end user device; instructions to send message data encoded using a message sponsor password from the first end user device to the second end user device; and instructions to send message sponsor password data from the first end user device to the second end user device selected by the first end user device.

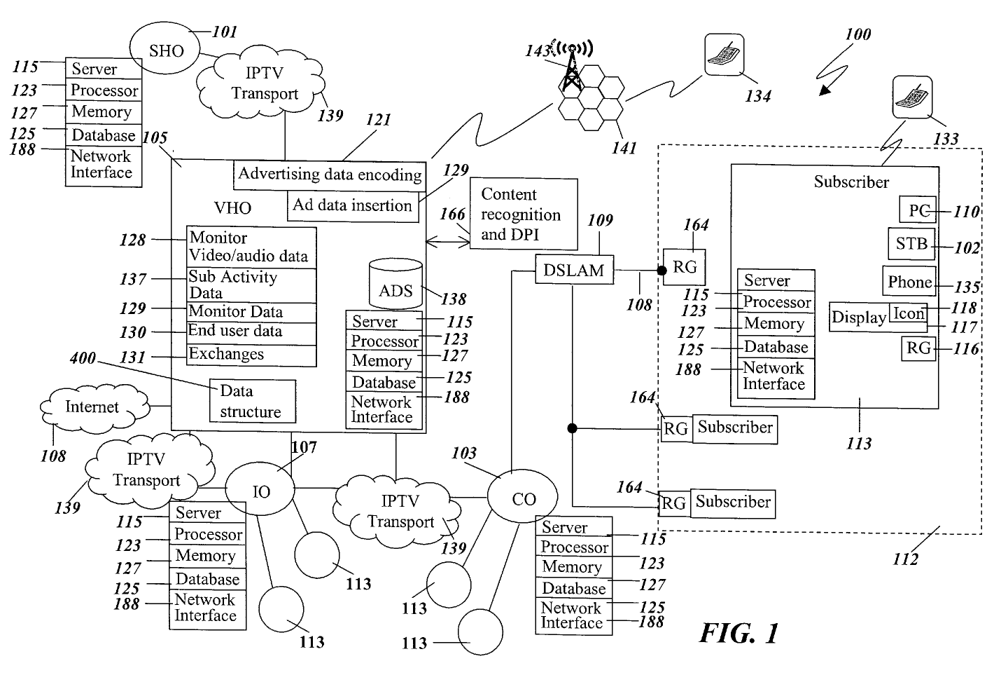

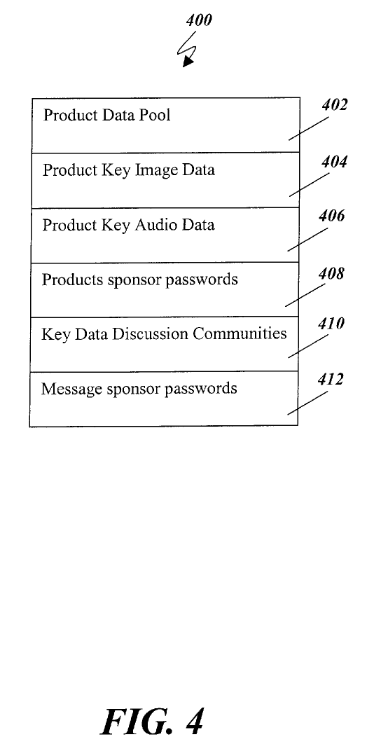

Turning now to FIG. 1, Turning now to FIG. 1, the IPTV system 100 delivers video data including but not limited to video data content, product and advertising data to end user households 113 and associated end user devices (also referred to herein as subscriber devices) which may be inside or outside of the household. The video data further includes but is not limited to product data keys are used to find product mage, text and audio which are embedded in the video data. The product data keys include but are not limited to text, audio, imagery and video data. The product data keys are found in the video data using content recognition including but not limited to an aural and speech recognition, text recognition and pattern recognition analysis of the video data and advertising data. Advertisers select particular product data keys categories for detection of advertising opportunities in the video data. When data in a particular product data key category are detected in a video data stream, advertising data placed in the video data or an associated data stream upon selection of the product from the video data by an end user device. The product data keys are stored in data structure 400, which is embedded in a computer readable medium or memory, discussed below in connection with FIG. 4.

Television advertising data, product data keys and advertising data keys are detected in the video data stream by content recognition computer programs and hardware in block 128 which monitors video and audio data. Product and advertising data keys are extracted from advertising data in the advertising data server 138. The sensed data keys are stored in a system key data pool 416 (discussed below in connection to the data structure of FIG. 4) by the advertising data server 138. Advertising data for the products are placed in the video data stream encoded by software and hardware in block 129 and encoded into the video data stream by advertising data encoding software and hardware 121. In the IPTV system, IPTV channels are first broadcast as video data in an internet protocol (IP) from a server at a super hub office (SHO) 101 to a regional or local IPTV video hub office (VHO) server 103, to an intermediate office (IO) server 107 and to a central office (CO) 103. The IPTV system 100 includes a hierarchically arranged network of servers where in a particular embodiment the SHO transmits video and advertising data to a video hub office (VHO) 103 and the VHO transmits to an end server location close to a end user device, such as a CO server 103 or IO 107.

In another particular embodiment, each of the SHO, VHO, CO and IO are interconnected with an IPTV transport 139. The IPTV transport 139 may consist of high speed fiber optic cables interconnected with routers for transmission of internet protocol data. The IPTV servers also provide data communication for Internet and VoIP services to subscribers. Actively viewed IPTV channels are sent in an Internet protocol (IP) data multicast group to access nodes such as digital subscriber line access multiplexer (DSLAM) 109. A multicast for a particular IPTV channel is joined by the set-top boxes (STBs) at IPTV subscriber homes from the DSLAM. Each SHO, VHO, CO, IO and STB includes a server 115, processor 123, a memory 127, network interface 188 and a database 125. Analysis of the video data for advertising data key insertion is performed by processor 123 at the VHO. The network interface performs functions to send and receive data over the IPTV transport. The CO server delivers IPTV, Internet and VoIP data to the subscriber via the IO and DSLAM. The television content is delivered via multicast and television advertising data via unicast or multicast depending on a target television advertising group of end user devices to which the product and advertising data is directed.

In another particular embodiment, subscriber devices, also referred to herein as end user devices, are different stationary and mobile devices, including but not limited to, wire line phones 135, portable phones 133, lap top computers 118, personal computers (PC) 110 and STBs 102, 119 communicate with the communication system, i.e., IPTV system through residential gateway (RG) 164 and high speed communication lines such as IPTV transport 139. In another particular embodiment, content recognition (CR) devices and deep packet investigation (DPI) devices 166 are implemented in software and hardware to inspect VoIP data, Internet data and IPTV video data, commands and Meta data (multicast and unicast) between the end user devices (subscriber devices) which are routed through the IPTV server and between the end user devices and the IPTV system severs. CR devices are used in analysis of the video data for detection of the advertising data keys based on advertising data categories stored in the data base 125. In a particular embodiment advertising and product data key forwarding exchange and discussion of advertising and product data keys and user-to-user connectivity are detected by the CR/DPI devices that monitor data sent between end user devices.

End user source and destination identifier data included in data sent between end user devices are used to track user-to-user connectivity that is, data exchanges between end user devices. Image, text and sound recognition functions are used to detect product key advertising key data exchanges, discussions and forwarding of product data in addition to the CR devices. Textual and aural key words and imagery found in the advertising data and messages sent and received by end user devices are inspected by the DPI/CR devices 166 and image recognition functions in the processors 123 in the communication system servers and end user devices are used as indicators of data keys and data related to advertising data in an advertising data pool found in messages sent between users from discussions and data forwarding of the data keys and other data relating to the advertising data between users, also referred to herein as end user devices. A particular embodiment tracks discussions between end users to determine which end user devices exchanging product data with each other, how often and the presence of product key related data in their data exchanges. The end users identity remains anonymous.

In another illustrative embodiment data exchanges between end users related to the product and advertising data keys are monitored and collected whether or not the subscriber's devices are in the household 113 or mobile outside of the household, such as cellular phones 134. When outside of the household, subscriber mobile device data are monitored by communication network (e.g. IPTV) servers and DPI/CR devices which associate the product and advertising data and product and advertising key data exchanges between particular end users with particular subscribers.

In another particular embodiment, the end user devices or subscriber devices include but are not limited to a client user computer, a personal computer (PC) 110, a tablet PC, a set-top box (STB) 102, a Personal Digital Assistant (PDA), a cellular telephone 134, a mobile device 134, a palmtop computer 134, a laptop computer 110, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. In another particular embodiment, a content recognition (CR) device 166 inspects multicast and unicast data, including but not limited to VoIP data, Internet data and IPTV video, commands and Meta data exchange between the end user devices and between end user devices and the IPTV system servers.

In another illustrative embodiment data exchanges between end users are monitored using the DPI/CR devices and collected whether or not the subscriber devices are in the household 113 or the devices are mobile devices 134 outside of the household. When outside of the household, subscriber mobile device data is monitored by a communication system (e.g., IPTV) servers which associate the data exchanges between end user devices with each particular subscriber's end user device. End users with the most discussion activity, that is, those end users whom discuss or exchange data that correlate with advertising data keys and product data keys with other end user devices the most frequently are classified as highly connected users (HCUs) based on the member end user discussions of advertising data keys and product, between the HCU and with other end user devices. For example, the words “bike” and “Tour de France” or an image of a bicycle correlate with bicycle product data, where an image or mention of an automobile does not.

As shown in FIG. 1 advertising sub groups 112 (comprising a group of end user subscriber house holds 113) receive multicast advertising data and advertising data keys in video data stream from IO server 107 via CO 103 and DSLAM 109 at STB 102. In another particular embodiment, each end user device STB is configured to perform DVR functionality using memory, processor and data base on board the STB. Individual households 113 receive advertising data at set top box 102 or one of the other subscriber devices. More than one STB (see STB1 102 and STB2 119) can be located in an individual household 113 and each individual STB can receive a separate multicast or unicast advertising stream on IPTV transport 139 through DSLAM 109. In another particular illustrative embodiment separate and unique product and advertising data are displayed at each set top box (STB) 102, 119 tailored to target the particular subscriber watching television at that particular STB. Each STB 102, 119 has an associated remote control (RC) 116 and video display 117. The subscriber via the RC selects product data, enters message and sponsor password data, selects channels for a video data viewing selection (video programs, games, movies, video on demand), and initiates trick play commands data to the STB/DVR and places orders for products and services over the IPTV system 100. Advertising and product data keys are generated and inserted at the VHO and used to select product and advertising data that are then sent to end user devices. In another embodiment, advertising data keys are generated at the end user devices by processors at the end user devices. Advertising and product data are selected for display by the end user devices based on processing of the advertising and product data keys described herein.

FIG. 1 depicts an illustrative communication system, including but not limited to a television advertising insertion system wherein television advertising and product data are encoded and inserted at an IPTV (SHO, VHO, CO) server or at the end user client subscriber device, for example, an STB, mobile phone, web browser or personal computer. Advertising data can be encoded and inserted into an IPTV video stream via advertising insertion device 129 at the IPTV VHO server 105 or at one of the STBs 102, 109. The IPTV servers include an advertising server 138 and an advertising database 125. The advertising data is selected by advertising monitoring element 129 from the advertising database 125 based on subscriber profile also referred to as end user data 130 and delivered by the VHO advertising server 138 to the IPTV VHO server 115. End users exchange of data that correlates with product and advertising key data is monitored and stored in memory 131. An SHO 101 distributes video, advertising and subscriber profile data to a regional VHO 103 which distributes data to local COs 105 which distribute product and advertising data via 10 107 to a digital subscriber access line aggregator multiplexer (DSLAM) access node to subscriber devices such as STBs 102, 119, PC 110 wire line phone 135, mobile phone 133 etc.

End user devices are placed in communities by product interest based on discussion or exchange of product data keys and advertising data keys with other end user devices as monitored by the DPI/CR devices. End users associated with particular end user devices are placed in communities of product interest based on the end user devices exchange of product data keys and advertising data keys. For example, end users who exchange (discuss) product and/or advertising data that correlates with “automobiles” are placed in an “automobile” product community. Similarly, end users who exchange product and/or advertising data that correlates with “bicycles” are placed in a “bicycle” product community. Some or all of the end users whom are placed in the automobile product community can also be placed in the bicycle product community. Thus, advertisers who want to sell automobiles request that the IPTV system place advertising data and product data in the video data and send highlighted portions of the video data that feature product data for automobiles to end user devices in the automobile product community. Similarly, advertisers who want to sell bicycles request that the IPTV system place product data in data video and send highlighted portions of the data video that feature bicycles product data to end user devices in the bicycle product community.

Advertising data are also selected based on the product community profile for end users in the product community and sent to a mobile phone or computer associated with the or end user devices in the community. The community subscriber profile is built based on anonymous advertising data and product data exchanges between end users in a community of end users monitored from end users monitored data exchanges from chat, instant messaging and VoIP activity and other data exchanges between end user devices. Subscriber activity data 137 are stored and represent advertising and product key data exchanged between end users during data exchanged via email, instant messages and VoIP phone data exchanges etc. for each end user device and advertising and product key data exchanged between end user devices and the IPTV system in data exchanges during purchases, television program selection and web page surfing.

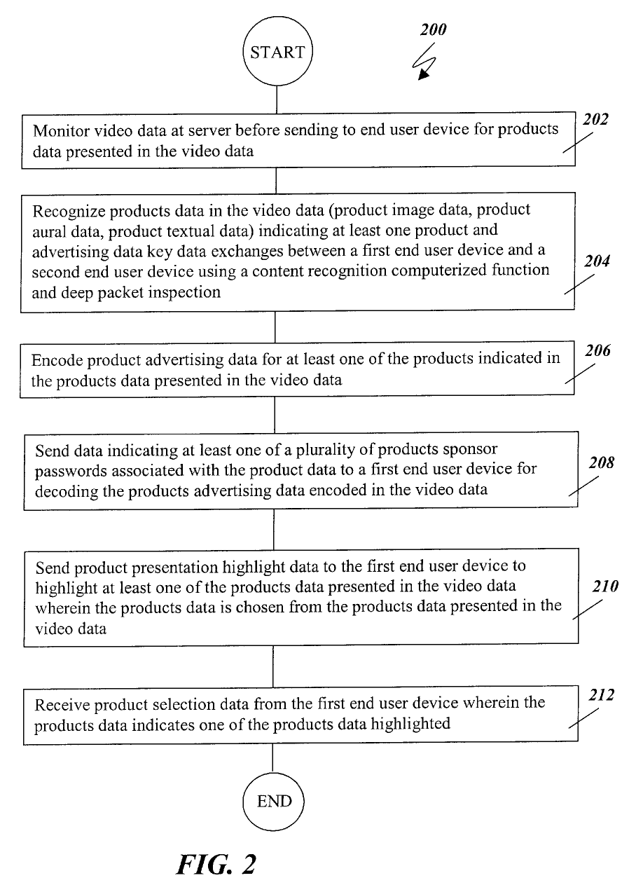

Turning now to FIG. 2, in a particular illustrative embodiment, a set of functions are executed as shown in FIG. 2. No order of execution is mandated by FIG. 2, as in other illustrative embodiments, functions are executed in a different order, additional functions not shown in FIG. 2 are performed and some of the functions shown in FIG. 2 are left out of execution. As shown in FIG. 2, at block 202, a particular illustrative embodiment monitors video data at a server before sending the video data to end user device for data that correlate with products data presented in the video data. For example, a particular advertiser wants to advertise a bicycle and places a request for advertising with the IPTV network. Advertising and product data keys including but not limited to image data, audio data and text data for or related to a bicycle are placed into product data pool in data structure 400, discussed below in association with FIG. 4. At block 204, a particular illustrative embodiment then recognizes data that correlates with products data in the video data (product image data, product aural data, and product textual data). The products data are correlated with the video data indicating at least one product and advertising data key data are exchanged between a first end user device and a second end user device using a content recognition (CR) computerized function and deep packet inspection (DPI). In a particular embodiment, during monitoring of end user product and advertising data exchanges, CR is performed on data packets in the IPTV system accessed using DPI.

At block 206, a particular illustrative embodiment then encodes product advertising data for at least one of the products indicated in the products data presented in the video data. In the present example, when bicycle data is found in the video data stream, product and advertising data for a bicycle are encoded in the video data stream. Members of the bicycle product community are sent highlight data by the IPTV system, which highlights the appearance of the bicycle product data in the video data stream when presented on an end user device in the bicycle product community. The highlighted image of the bicycle products data in the video data stream, which appears highlighted, are sent to end users in the bicycle community, which alerts the end users in the bicycle product community that the highlighted bicycle in the video data available stream has advertising data associated the bicycle. The advertising data that can be accessed by using a remote control cursor to click on the highlighted bicycle data in the video data stream presented on the end user device.

At block 208, a particular illustrative embodiment then sends data indicating at least one of a plurality of products sponsor passwords data associated with the product data to a first end user device for decoding the products advertising data encoded in the video data. End user device members of the bicycle community are sent bicycle sponsor password data by the IPTV system from advertisers who want to market bicycle products to the end users associated with the end user devices in the bicycle product community. End user device members of the automobile product community are sent automobile sponsor password data by the IPTV system from advertisers who want to market automobile products to the end users associated with the end user devices in the automobile community.

At block 210, a particular illustrative embodiment then sends product presentation highlight data to a first end user device to highlight at least one of the products data presented in the video data wherein the products data is chosen from the products data presented in the video data. In the present example, highlight data for the bicycle is sent to end user devices in the bicycle product community. The lighting data is applied to the video data stream at the end user device. Thus only end users in the bicycle product community see a highlighted bicycle in the video data presented at the end user device. At block 212, a particular illustrative embodiment then receives product selection data from the first end user device wherein the products data indicates one of the products data highlighted and selected in the video data. In the present example, the first end user associated with the first end user device in the bicycle product community, clicks on the highlighted image of the bicycle on the end user device. The end user device sends the product selection data, selecting the bicycle to the IPTV system.

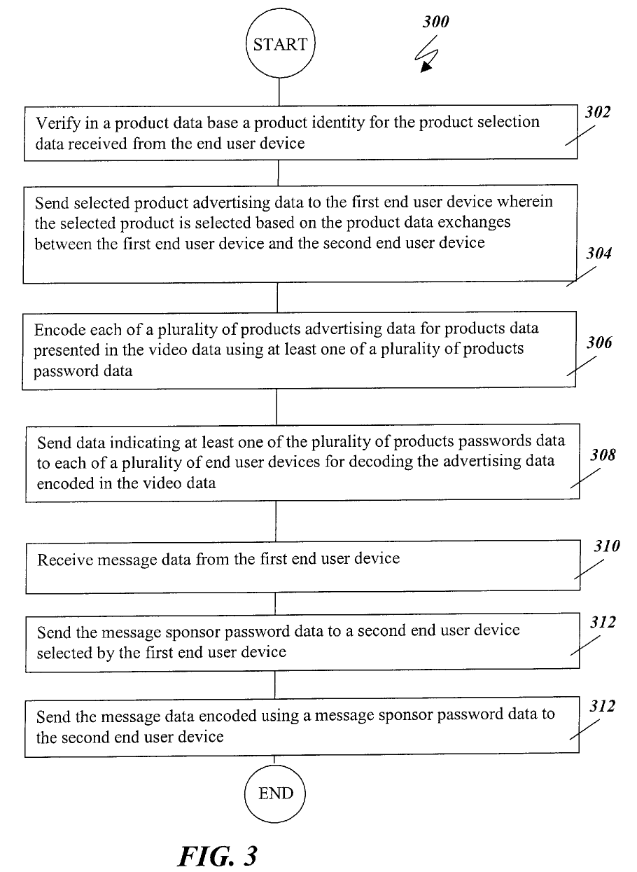

Turning now to FIG. 3, at block 314, a particular illustrative embodiment then verifies in a product data base a product identity for the product selection data received from the end user device. In a particular embodiment, an advertiser provides a product reference image and a product reference image watermark to verify that the product highlighted in the video data stream is the product for which the advertiser wants to send advertising data. In a particular embodiment, the product selected is compared to the product reference image to verify that the selected product data is a product for which the advertiser wants to advertise. In another embodiment, an index associated with the product reference image is used to access particular product sponsor password data for use in encoding and decoding advertising data into the video data stream containing the product data, for example, the bicycle product image in the video data stream.

In another particular embodiment, a product watermark for the product selected is compared to the product reference image watermark to verify that the selected product data is a product for which the advertiser wants to advertise. The watermark is one example of verification data for use in verifying the presence of particular product data in the video data.

At block 316, a particular illustrative embodiment then sends advertising data for the selected product data and product sponsor password data to the first end user device wherein the selected product data is selected based on the data exchanges that correlate with the product data between the first end user device and the second end user device. Different bicycle products data advertising data can be sent to different end users based on the product data exchanges. At block 318, a particular illustrative embodiment then encodes each of a plurality of advertising data for products data presented in the video data using at least one of a plurality of products sponsor password data. At block 320, a particular illustrative embodiment then sends data indicating at least one of the plurality of products sponsor passwords data to each of a plurality of end user devices for decoding the advertising data encoded in the video data. At block 322, in a particular illustrative embodiment, the IPTV system then receives message data from the first end user device. The IPTV system encodes the message data with a message sponsor password and sends the message sponsor password data to a second end user device destination, which end user device destination is selected by the first end user device. The message sponsor password data can be different than the product sponsor password. For example, the selected second end user device destination may be a member of the automobile product community and thus automobile message sponsor password data is used to encode and decode the message. The second end user enters to automobile message sponsor password data to open and decode sponsored encoded the message from the first end user. At block 324, a particular illustrative embodiment then sends the message data encoded using message sponsor password data to the second end user device.

Another particular illustrative embodiment monitors the IPTV video data using content recognition hardware and software embedded in a computer readable medium to monitor and identify product data and product key data in the video data before the video data is sent to the end user devices. The IPTV video data includes but is not limited to audio data, video and text data in a video data stream. In an illustrative embodiment, the IPTV system monitors the IPTV video data in the IPTV system for image data and audio data relating to products data in an advertising data pool, discussed below, and monitors the video data for product and advertising key data and image data extracted from the advertising data pool. The product and advertising key data include but are not limited to video, audio and image data for products, such as the bicycle in the above example, that appear in the video data stream. A particular illustrative embodiment generates a water mark and retrieves advertising data for the product key data and product data. An illustrative embodiment uses the product data key and water mark to access product sponsor passwords data for product advertising data encoded in video data.

A particular illustrative embodiment highlights product data in video data for end user interaction for a community of end users, that is, end users whom have exchanged product data and product key data about the product or have exchanged advertising key data for the product. A particular illustrative embodiment collects audience data from advertising key, image and audio data exchanged between end user to end user and between end user and internet domains. A particular illustrative embodiment receives encoded product identifiers in video image data with product video data.

A particular illustrative embodiment verifies an end user selected product identity in product data base. A particular illustrative embodiment finds advertising data to sponsor messages between a first and second end user, device. A particular illustrative embodiment encodes multiple product advertising data for multiple end user devices and multiple products with multiple product passwords and water marks for each product. End users in different product communities receive different product passwords so that end users in a bicycle product community can select and decode bicycle advertising data and so that end users in an automobile product community can select and decode automobile advertising data. A particular illustrative embodiment encodes multiple products advertising data for multiple users and multiple products with multiple passwords, reference images and watermarks for each product. A particular illustrative embodiment sends product sponsor password data and water marks or commercial signatures, for advertising decode to end user devices based on product pool data exchanges discussions for user based on advertising. A particular illustrative embodiment sends multiple products data encoded in separate video images data for different products to each end user device in an end user product community in which the separate video images for different end user device communities are interleaved within video frames in the video data stream. Thus different end user device communities can receive different product advertising data and different product sponsor passwords for the different product advertising data.

In another particular illustrative embodiment, the IPTV system selects product data and product sponsor password data for product data that appease in the video data and correlates with product key data. In a particular illustrative embodiment, a second end user device receives message data from the first end user device (sender), selects advertising a message sponsor for the second end user device based on exchange of data that correlates with product data between the first end user and the product community of end users to whom the first end user belongs. A particular illustrative embodiment captures message data from the first end user device and encodes the message into a video data stream using message sponsor password data, e.g. “Speedeez Racer Bikes.” The IPTV system then sends the encoded message data, encoded with the message sponsor password, to the second end user device along with the sponsor password to message to the second end user. The second end user at the second end user device enters the message sponsor password to decode the message data from the first end user device.

Another particular illustrative embodiment detects products data in the video of data stream using CR and DPI software and hardware for recognition of image and audio data related to products data in the video data stream for products data that appear in the advertising data pool. A particular illustrative embodiment marks and extracts product data in a video segment from the video data stream for products selected by an end user device and for products relating to the advertising data pool products dats. A particular illustrative embodiment verifies the product data identity that appears in the video data stream or is selected by an end user device with a reference image or a reference image and watermark for the product image data or product audio data for the video data of the product selected.

A particular illustrative embodiment retrieves a sponsor password for the product data from a database using a reference image or digital fingerprint for product data. A particular illustrative embodiment encodes advertising data and products data in video image data using the password for the product data. Multiple product sponsor passwords data are sent to multiple end user devices and end user device product communities, based on the product communities, and advertising key data communities to which the end user devices belong. A particular illustrative embodiment updates the decoded advertising data encoded in the video data using the password and re-encodes new or updated advertising data into the video image data with the updated product data and advertising data. A particular illustrative embodiment sends updated advertising data encoded into the video data to end user devices in the product communities to end user devices in the product communities and advertising communities formed by the IPTV system.

An illustrative embodiment selects product data for advertising product data which are presented to the end user device related to a product selected from the video data stream, to present advertising data, and purchase data or informational data based on the demographics of the end users associated with end user devices in the key data communities and end user devices in the product communities. A correlation is performed between the product key data pool key and the end user device from discussions or data exchanges between the end user devices. An illustrative embodiment sends product sponsor password data to end user devices which the end user devices use to decode advertising and information data for the selected products for presentation to a particular end user device in an end user key product community.

Another illustrative embodiment sends product highlight data and an advertising data watermark to end user devices and decodes a password from the watermark for use by an end user device to display the highlighted product data in the video at the end user device. An illustrative embodiment receives product selection advertising data and uses the product password to decode the advertising data in the video images for display at an end user device.

Turning now to FIG. 4, in an illustrative embodiment, a data structure is provided embedded in computer readable medium for containing data useful in performing the functions performed by the system and method disclosed herein. In another embodiment, a computer program including instructions that when executed by a processor perform a particular function performed by the system and method. As shown in FIG. 4 in an illustrative embodiment, a data structure is provided, including but not limited to a first data field 402 for containing the product data pool data containing data indicating products data and associated products advertising data to be sent to end user devices encoded in video data streams upon user selection of highlighted products data from the video data stream. An illustrative embodiment further includes but is not limited to a second data structure field 404 for containing data indicating product key image data for products presented in the video data stream and presented to end users at end user devices.

An illustrative embodiment further includes but is not limited to a third field 406 in the data structure for containing data indicating product key audio data in the video data stream indicating products selected and presented by the system to an end-user device. An illustrative embodiment further includes but is not limited to a fourth field 408 in the data structure for containing data indicating products sponsor passwords associated with products selected by discussion communities of end user devices. An illustrative embodiment, further includes but is not limited to a fifth field 410 in the data structure for containing data indicating key data discussion communities of end user devices, which indicate end user devices which exchange product data between end users associated with end user devices in the product community of end user devices. An illustrative embodiment further includes but is not limited to a data structure field 412 for containing data indicating message sponsor passwords data to be used by the IPTV system to encode and decode a message sent to an end user device.

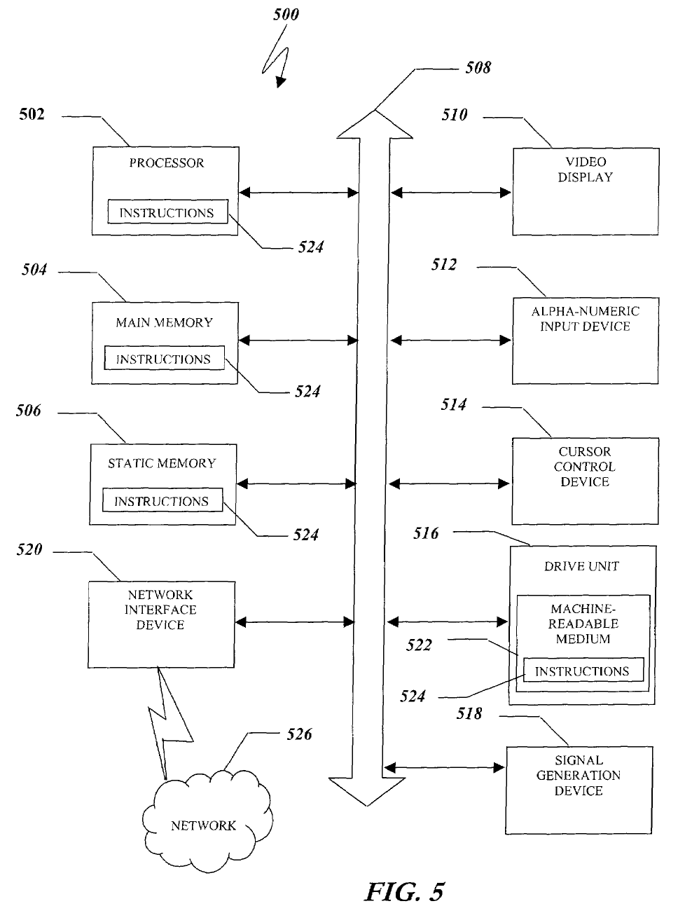

FIG. 5 is a diagrammatic representation of a machine in the form of a computer system 500 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., liquid crystals display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface.

The disk drive unit 516 may include a machine-readable medium 522 on which is stored one or more sets of instructions (e.g., software 524) embodying any one or more of the methodologies or functions described herein, including those methods illustrated in herein above. The instructions 524 may also reside, completely or at least partially, within the main memory 504, the static memory 506, and/or within the processor 502 during execution thereof by the computer system 500. The main memory 504 and the processor 502 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 524, or that which receives and executes instructions 524 so that a device connected to a network environment 526 can send or receive voice, video or data, and to communicate over the network 526 using the instructions 524. The instructions 524 may further be transmitted or received over a network 526 via the network interface device 520. The machine readable medium may also contain a data structure for containing data useful in providing a functional relationship between the data and a machine or computer in an illustrative embodiment of the disclosed system and method.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer readable medium containing a computer program comprising instructions, the computer program comprising instructions to monitor video data for products data presented in the video data; instructions to encode product advertising data for at least one of the products data presented in the video data; instructions to send at least one of a plurality of products sponsor passwords data to a first end user device for decoding the products advertising data encoded in the video data; instructions to receive message data from the first end user device; instructions to send message sponsor password data to a second end user device selected by the first end user device; and instructions to send the message data encoded using the message sponsor password data to the second end user device.

2. The medium of claim 1, wherein the at least one products sponsor password data and the message sponsor password data indicate at least one advertising term selected from an advertising sponsor data base.

3. The medium of claim 1, wherein the products sponsor passwords data and the message sponsor data are the same.

4. The medium of claim 1, wherein the instructions to monitor the video data further comprise instructions to recognize data in the video data containing at least one of product image data, product aural data and product textual data and advertising data key data exchanges between the first end user device and the second end user device using a content recognition computerized function.

5. The medium of claim 4, the computer program further comprising instructions to send product presentation highlight data to the first end user device to highlight at least one of the products data presented in the video data wherein the products data is chosen from the products data presented in the video data.

6. The medium of claim 5, the computer program further comprising instructions to receive product selection data from the first end user device wherein the products data indicates one of the products data highlighted; and Instructions to verify in a product data base a product identity for the product selection data received from the end user device.

7. The medium of claim 4, the computer program further comprising instructions to send selected product advertising data to the first end user device wherein the selected product is selected based on the product data exchanges between the first end user device and the second end user device.

8. The medium of claim 1, the computer program further comprising instructions to encode each of a plurality of products advertising data for products data presented in the video data using at least one of a plurality of products password data; and instructions to send data indicating at least one of the plurality of products sponsor passwords data to each of a plurality of end user devices for decoding the advertising data encoded in the video data.

9. The medium of claim 1, wherein the advertising sponsor password data is an advertising sponsor password associated with the product data.

10. A computerized system for sending sponsored data, the system comprising:
A processor in data communication with a computer readable medium;
A computer program containing instructions for performing a method for sending advertising data, the computer program further comprising instructions to monitor video data for products data presented in the video data; instructions to encode product advertising data for at least one of the products data presented in the video data; instructions to send at least one of a plurality of products sponsor passwords data to a first end user device for decoding the products advertising data encoded in the video data; instructions to receive message data from the first end user device; instructions to send message sponsor password data to a second end user device selected by the first end user device; instructions to send the message data encoded using the message destination password data to the second end user device.

11. The system of claim 10, wherein the at least one products sponsor password data and the message sponsor destination password data indicate at least one advertising term selected from an advertising sponsor data base.

12. The system of claim 10, wherein the products sponsor passwords data and the message sponsor data are the same.

13. The system of claim 10, wherein the instructions to monitor the video data further comprise instructions to recognize data in the video data containing at least one of product image data, product aural data and product textual data and advertising data key data exchanges between the first end user device and the second end user device using a content recognition computerized function.

14. The system of claim 13, wherein the computer program further comprises instructions to send product presentation highlight data to the first end user device to highlight at least one of the products data presented in the video data wherein the products data is chosen from the products data presented in the video data.

15. The system of claim 14, the computer program further comprising instructions to receive product selection data from the first end user device wherein the products data indicates one of the products data highlighted; and instructions to verify in a product data base a product identity for the product selection data received from the end user device.

16. The system of claim 13, the computer program further comprising instructions to send selected product advertising data to the first end user device wherein the selected product is selected based on the product data exchanges between the first end user device and the second end user device.

17. The system of claim 10, the computer program further comprising instructions to encode each of a plurality of products advertising data for products data presented in the video data using at least one of a plurality of products password data; and instructions to send data indicating at least one of the plurality of products passwords data to each of a plurality of end user devices for decoding the advertising data encoded in the video data.

18. The system of claim 10, wherein the advertising sponsor password data is an advertising sponsor password associated with the product data.

19. A computerized system for selecting products advertising data, the system comprising:
A first end user device having a processor in data communication with a computer readable medium;
A computer program containing instructions useful for performing a method for receiving from a server in a communication network, products advertising data encoded in video data, the computer program further comprising instructions to receive products data presented in the video data; instructions to decode product advertising data for at least one of the products data presented in the video data using one of a plurality of products sponsor passwords data received at the first end user device; instructions to send message data encoded using a message sponsor password from the first end user device to the second end user device; and instructions to send message sponsor password data from the first end user device to the second end user device selected by the first end user device.

20. A computer readable medium containing a computer program comprising instructions embedded in the computer readable medium for performing a method for selecting products advertising data, the computer program comprising instructions to receive from a server in a communication network, products advertising data encoded in video data, instructions to receive products data presented in the video data; instructions to decode product advertising data for at least one of the products data presented in the video data using one of a plurality of products sponsor passwords data received at the first end user device; instructions to send message data encoded using a message sponsor password from the first end user device to the second end user device; and instructions to send message sponsor password data from the first end user device to the second end user device selected by the first end user device.
